(19) United States
(12) Patent Application Publication
(10) Pub. No.: US 2023/0405917 A1
(43) Pub. Date: Dec. 21, 2023

(54) MOBILE PHONE SCREEN PROTECTIVE FILM HAVING DUST REMOVAL FUNCTION AND FILM PASTING AUXILIARY DEVICE

(71) Applicant: SHENZHEN MEINUOTENGFEI TECHNOLOGY CO., LTD., Shenzhen (CN)

(72) Inventor: BIN MO, Shenzhen (CN)

(21) Appl. No.: 17/860,283

(22) Filed: Jul. 8, 2022

(30) Foreign Application Priority Data
Jun. 18, 2022 (CN) 202221528040X

(51) Int. Cl. B29C 63/02; H04B 1/3888; B32B 7/12; B29C 63/00

(52) U.S. Cl. CPC B29C 63/02; H04B 1/3888; B32B 7/12; B29C 63/0004; B32B 2307/20; B32B 2571/00; B29K 2995/001; B29L 2031/768

(57) ABSTRACT

A mobile phone screen protective film having dust removal function and a film pasting auxiliary device are provided. An electrostatic protective film is disposed on an upper side of a mobile phone film body. A pulling film is disposed on an upper side of the electrostatic protective film. A connecting structure is disposed at front ends of the electrostatic protective film and the pulling film. An opening is defined on a main housing of the film pasting auxiliary device. A positioning frame is distributed in the main housing. A film body placing groove is extended out from the positioning frame in a direction of the opening. A positioning avoiding groove is defined on a first side of the positioning frame. A pulling opening is defined on a second side of the positioning frame. A positioning connecting mechanism is disposed between the main housing and the mobile phone film body.

### TECHNICAL FIELD

The present disclosure relates to a technical field of mobile phone protective films, and in particular to a mobile phone screen protective film having dust removal function and a film pasting auxiliary device.

### BACKGROUND

Mobile phone films, also referred to as mobile phone beauty films or mobile phone protective films, are one kind of cold laminating films configured to cover outer surfaces of mobile phone bodies, screens, and other tangible objects, and there are a wide variety of the mobile phone films. According to different uses, the mobile phone films are divided into mobile phone screen protective films and mobile phone body protective films. Functions of the mobile phone films are developed from original simple anti-scratch protective films to functional protective films, and the functional protective films are divided into an anti-peep film, a mirror film, an anti-Reflectance (AR) film, a frosted film, a high-definition film, an anti-scratch protective film, a 3D film, a mobile phone body anti-scratch protective film, a diamond film, a tempered film, etc.

At present, before pasting a protective film on a mobile phone screen, dust on the surface of the mobile phone screen needs to be removed through a dust removal sticker and only in the dust-free environment, the protective film can be pasted on the surface of the mobile phone screen. Even so, fine dust particles may still adhere between the protective film and the mobile phone screen to form bubbles, which is very difficult to process. Therefore, the present disclosure provides a mobile phone screen protective film having dust removal function and a film pasting auxiliary device to solve problems in prior art.

### SUMMARY

Aiming at above problems, a purpose of the present disclosure is to provide a mobile phone screen protective film having dust removal function and a film pasting auxiliary device.

A mobile phone film body is covered with an electrostatic protective film having static electricity. The electrostatic protective film has a function of adsorbing dust. When the electrostatic protective film is pulled out, the dust on a mobile phone screen is automatically adsorbed and taken away, and repeated dust removal procedures are not needed, which saves time and labor. Meanwhile, the film pasting auxiliary device helps position the mobile phone film on a corresponding mobile phone screen, so that a whole operation process of film pasting is more convenient and efficient.

In order to achieve the purpose of the present disclosure, the present disclosure is realized through following technical solutions.

The present disclosure provides a mobile phone screen protective film having dust removal function, including a mobile phone film body, an electrostatic protective film, and a pulling film. The electrostatic protective film is disposed on an upper side of the mobile phone film body. The pulling film is disposed on an upper side of the electrostatic protective film. A connecting structure is disposed at a front end of the electrostatic protective film and a front end of the pulling film. The electrostatic protective film and the pulling film are connected into a whole through the connecting structure. The connecting structure connects the electrostatic protective film and the pulling film into a whole. The electrostatic protective film is torn off when pulling out the pulling film.

Furthermore, the connecting structure is a connecting film.

Furthermore, a pulling portion, distal from the connecting structure, is disposed on the pulling film. The pulling portion protrudes out of an edge of the electrostatic protective film and an edge of the mobile phone film body. When pasting the mobile phone screen protective film, pinching the pulling portion and pulling out the pulling film until the electrostatic protective film is further torn off.

Furthermore, a positioning film is disposed at a front end of a lower side of the mobile phone film body. The positioning film is disposed in a T shape. A transverse end of the T shape is attached to an upper end of the mobile phone film body, corners of the T shape correspond to the mobile phone film body. Positioning sleeve holes are defined on an extension section of the T shape of the positioning film.

The present disclosure further provides a film pasting auxiliary device for the mobile phone screen protective film having dust removal function, including a main housing, a positioning frame, a film body placing groove, a positioning avoiding groove, a pulling opening, an opening, and a positioning connecting mechanism. The positioning frame is distributed in the main housing. A size of the positioning frame is the same as a size of an electronic product to be filmed. The film body placing groove extends out from the positioning frame along a direction of the opening. A size of the film body placing groove is matched with the mobile phone film body. The positioning avoiding groove is defined on a first side of the positioning frame. The positioning avoiding groove and the film body placing groove are on a same horizontal plane and are formed into a whole. The pulling opening is defined on a second side of the positioning frame. A width of the pulling opening is the same as a width of the pulling film and a width of the electrostatic protective film. The opening is defined on the main housing, and the opening is defined on a surface of the main housing in a strip shape. The positioning connecting mechanism is disposed between the main housing and the mobile phone film body.

Furthermore, the positioning connecting mechanism includes a positioning film, positioning sleeve holes, and positioning columns. The positioning film is disposed at a front end of a lower side of the mobile phone film body. The positioning sleeve holes are defined on a front end of the positioning film. The positioning columns are disposed in the main housing on one side of the positioning avoiding groove, and the positioning columns are disposed with respect to the positioning sleeve holes.

Furthermore, the positioning connecting mechanism includes a connecting member, and the connecting member is disposed on a back surface of the main housing. The connecting member covers on the opening, and one side, where an adhesive portion is disposed, of the connecting member faces the mobile phone film body.

Furthermore, the connecting member is an adhesive sticker.

Beneficial effects of the present disclosure are as follows.

The present disclosure provides the electrostatic protective film having static electricity to cover on the mobile phone film body. when the electrostatic protective film is pulled out, the dust on a mobile phone screen is automatically adsorbed and taken away through the electrostatic protective film, and repeated dust removal procedures are not needed, which saves time and labor.

### BRIEF DESCRIPTION OF DRAWINGS

FIG. 1 is a schematic diagram of a front elevational view of a mobile phone screen protective film having dust removal function according to one embodiment of the present disclosure.

FIG. 2 is a cross-sectional schematic diagram of the mobile phone screen protective film having dust removal function according to one embodiment of the present disclosure.

FIG. 3 is a schematic diagram of a front elevational view of the mobile phone screen protective film having dust removal function where a positioning film is added according to one embodiment of the present disclosure.

FIG. 4 is a cross-sectional schematic diagram of the mobile phone screen protective film having dust removal function where the positioning film is added according to one embodiment of the present disclosure.

FIG. 5 is an exploded schematic diagram of a front surface of a film pasting auxiliary device for fixing a mobile phone film using a connecting member according to one embodiment of the present disclosure.

FIG. 6 is an exploded schematic diagram of a back surface of the film pasting auxiliary device for fixing the mobile phone film using the connecting member according to one embodiment of the present disclosure.

FIG. 7 is an exploded schematic diagram of a front surface of the film pasting auxiliary device for fixing the mobile phone film using positioning columns according to one embodiment of the present disclosure.

FIG. 8 is an exploded schematic diagram of a back surface of the film pasting auxiliary device for fixing the mobile phone film using the positioning columns according to one embodiment of the present disclosure.

### REFERENCE NUMBER IN THE DRAWINGS

1. mobile phone film body; 2. electrostatic protective film; 3. pulling film; 4. connecting structure; 5. pulling portion; 6 main housing; 7. positioning frame; 8. positioning avoiding groove; 9. pulling opening; 10. opening; 11. positioning columns; 12. positioning film; 13. positioning sleeve holes; 14. connecting member; and 15. film body placing groove.

### DETAILED DESCRIPTION

In order to deepen understandings of the present disclosure, the present disclosure is further described in details below with reference to embodiments. The embodiments of the present disclosure are only configured to explain the present disclosure, but do not constitute a limitation on a protection scope of the present disclosure.

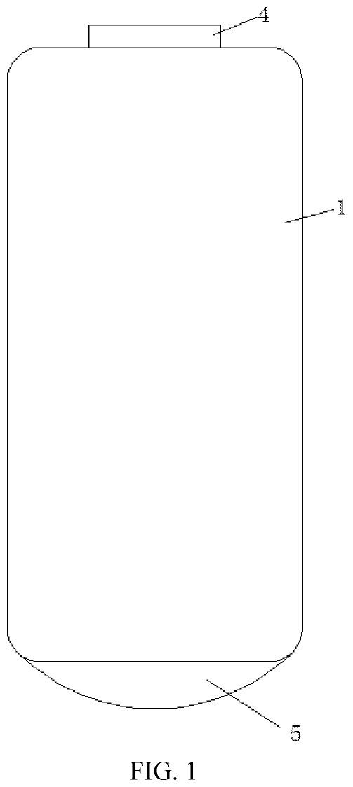

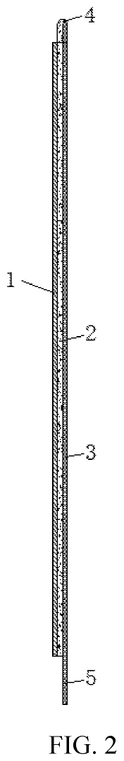

As shown in FIGS. 1 and 2, the present disclosure provides a mobile phone screen protective film having dust removal function, including: a mobile phone film body 1, an electrostatic protective film 2, and a pulling film 3. The electrostatic protective film 2 is disposed on an upper side of the mobile phone film body 1. The pulling film 3 is disposed on an upper side of the electrostatic protective film 2. A connecting structure 4 is disposed at a same side of the electrostatic protective film 2 and the pulling film 3. The electrostatic protective film 2 and the pulling film 3 are connected into a whole through the connecting structure 4. The electrostatic protective film 2 is torn off when pulling out the pulling film 3.

A pulling portion 5, distal from the connecting structure 4, is disposed on the pulling film 3. The pulling portion 5 protrudes out of an edge of the electrostatic protective film 2 and an edge of the mobile phone film body 1. When pasting the mobile phone screen protective film, pinching the pulling portion 5 and pulling out the pulling film 3 until the electrostatic protective film 2 is further torn off. The connecting structure 4 is a connecting film.

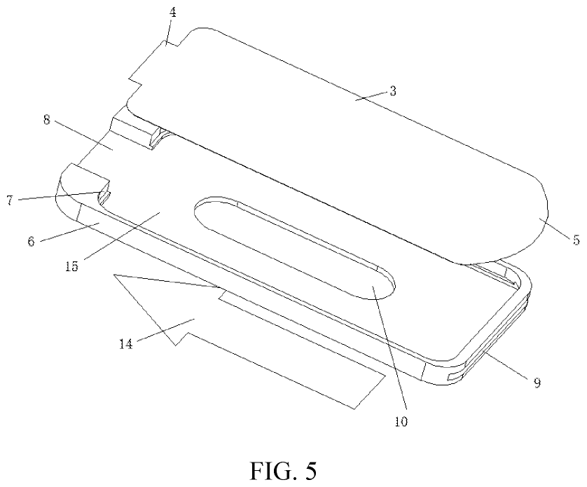

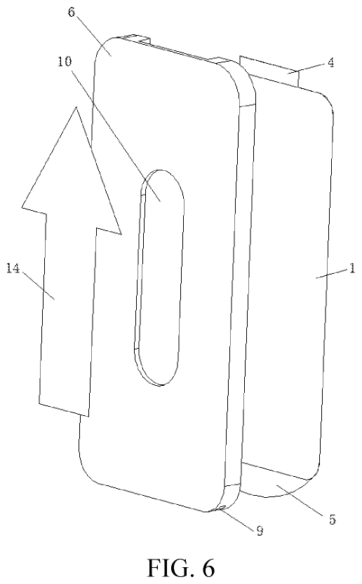

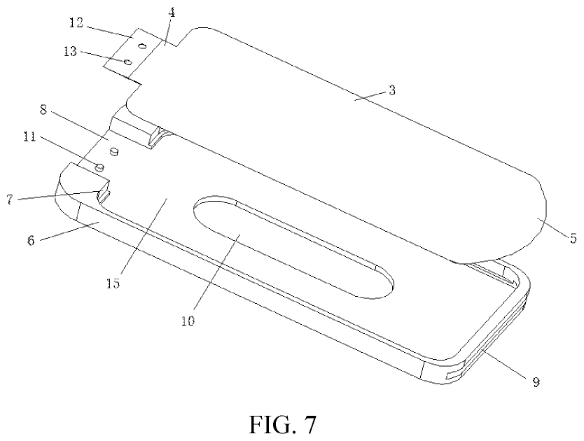

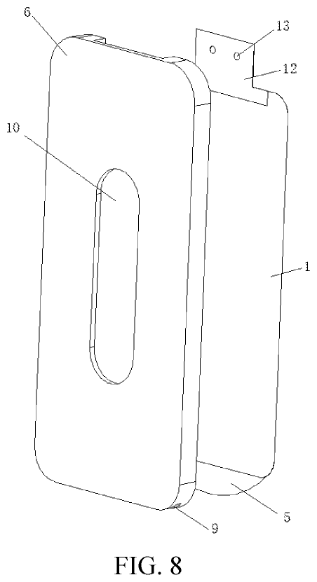

As shown in FIGS. 5-8, the present disclosure provides a film pasting auxiliary device for the mobile phone screen protective film having dust removal function, including a main housing 6, a positioning frame 7, a film body placing groove 15, a pulling opening 9, an opening 10, and a positioning connecting mechanism. The opening 10 is defined on the main housing 6, and the opening 10 is defined on a surface of a middle portion of the main housing 6 in a strip shape. The positioning frame 7 is distributed in a front surface of the main housing 6. A size of the positioning frame 7 is the same as a size of an electronic product to be filmed. The film body placing groove 15 extends out from the positioning frame 7 along a direction of the opening 10. A size of the film body placing groove 15 is matched with the mobile phone film body 1. The positioning avoiding groove 8 is defined on a first side of the positioning frame 7. The positioning avoiding groove 8 and the film body placing groove 15 are on the same horizontal plane and form a whole. The pulling opening 9 is defined on a second side of the positioning frame 7. A width of the pulling opening 9 is same as a width of the pulling film 3 and a width of the electrostatic protective film 2. The positioning connecting mechanism is disposed between the main housing 6 and the mobile phone film body 1.

However, due to a fact that the mobile phone screen protective film is not fixed, the mobile phone screen protective film is easy to slide in the film body placing groove. When the mobile phone screen protective film is going to align and paste on a mobile phone screen, it is not easy to align the mobile phone screen protective film with the mobile phone screen, and it is easy to crookedly paste mobile phone screen protective film, which increases probability of failing to film the mobile phone screen. Therefore, aiming at the problem, the mobile phone screen protective film is fixed through following two ways of embodiment 1 and embodiment 2 to complete the whole film pasting process.

### Embodiment 1

As shown in FIGS. 1, 2, 5, and 6, a removable adhesive connecting member 14 is disposed on a back surface of the main housing 6. The connecting member 14 covers on an outer surface of the opening 10, and one side, where an adhesive portion is disposed, of the connecting member 14 faces the mobile phone film body 1. The connecting member 14 is an adhesive sticker. When pasting the mobile phone screen protective film, the mobile phone film body 1 is placed on the film body placing groove 15, and the connecting member 14 is pressed and pasted on an edge of the opening 10 and the mobile phone film body through the opening 10, so as to fix the mobile phone screen protective film in the film body placing groove 15, and prevent the mobile phone screen protective film from sliding. The pulling portion 5 of the pulling film 3 passes through the pulling opening 9, then a mobile phone is slightly raised, and the main housing 6 is turned over with a back surface of the main housing 6 facing up and a front surface of the main housing 6 covering on the mobile phone screen, so that an inner and lower side edge of the front surface of the main housing 6 is aligned with a side edge of a charging port of the mobile phone. Then pinching the pulling portion 5 at a lower end of the pulling film 3 and pulling out the pulling portion 5 until the electrostatic protective film 2 is further completely pulled out, and the mobile phone film body 1 is attached to the mobile phone screen through pressing the connecting member 14 by hand via the opening 10 on the back surface of the main housing 6. Then the connecting member 14 is torn off, and the film pasting auxiliary device is taken down to complete the film pasting. Due to a fact that the electrostatic protective film 2 has an electrostatic adsorption effect, the electrostatic protective film 2 automatically absorbs and takes away the dust on the mobile phone screen when the electrostatic protective film is pulled away, so that a surface of the mobile phone screen is clean and dust-free, and the mobile phone film body is more perfectly attached to the mobile phone screen.

### Embodiment 2

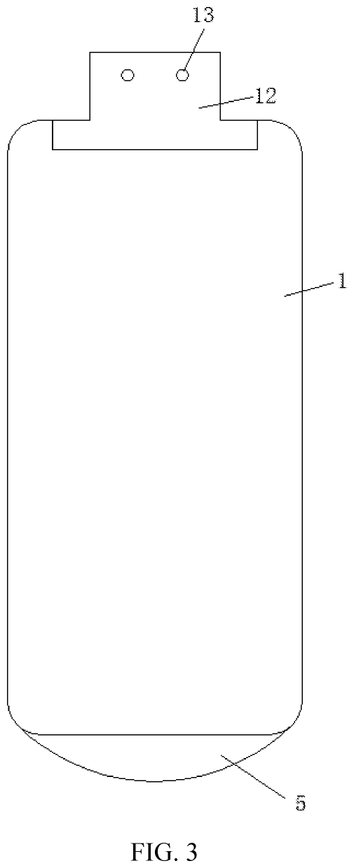

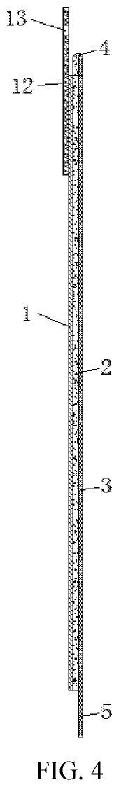

As shown in FIGS. 3, 4, 7, and 8, a positioning film 12 is disposed at a front end of a lower side of the mobile phone film body 1. The positioning film 12 is disposed in a T shape. A transverse end of the T shape is attached to an upper end of the mobile phone film body 1, corners of the T shape correspond to the mobile phone film body 1. Positioning sleeve holes 13 are defined on an extension section of the T shape of the positioning film 12. Positioning columns 11 are disposed on the positioning avoiding groove 8 on the first side of the positioning frame 7 on the front surface of the main housing 6, and the positioning columns 11 are disposed with respect to the positioning sleeve holes 13. When pasting the mobile phone screen protective film, the positioning sleeve holes 13 on the positioning film 12 are covered on the positioning columns 11, and then the positioning sleeve holes 13 are pressed down. The mobile phone film body 1 is matched with the film body placing groove 15. The pulling portion 5 of the pulling film 3 passes through the pulling opening 9, then a mobile phone is slightly raised, and the main housing 6 is turned over with a back surface of the main housing 6 facing up and a front surface of the main housing 6 covering on the mobile phone screen, so that an inner and lower side edge of the front surface of the main housing 6 is aligned with a side edge of a charging port of the mobile phone. Then pinching the pulling portion 5 at a lower end of the pulling film 3 and pulling out the pulling portion 5 until the electrostatic protective film 2 is further completely pulled out, and the mobile phone film body 1 is attached to the mobile phone screen through pressing the mobile phone film body 1 by hand via the opening 10 on the back surface of the main housing 6. Then the film pasting auxiliary device is taken down, and the positioning film 12 is torn off to complete the film pasting.

The viscous connecting member in the embodiment 1 and the positioning columns on the main housing in the embodiment 2 are only two of positioning structures of the mobile phone screen protective film. There are other positioning methods, such as disposing adhesive connecting members on the surface of the mobile phone film body or in the film body placing groove on the main housing, which further realizes positioning between the mobile phone screen protective film and the film pasting auxiliary device. Details may not describe herein.

Basic principles, main features and advantages of the present disclosure are shown and described above. It should be appreciated by people skilled in art that the present disclosure is not limited by the above embodiments. The above mentioned embodiments and descriptions are merely illustrative of the principles of the present disclosure. Variations and improvements are made in the present disclosure without departing from spirit and the scope of the present disclosure, and the variations and the improvements fall within the scope of the present disclosure as claimed. The scope of the present disclosure is defined by the appended claims and equivalents of the appended claims.

What is claimed is:

1. A mobile phone screen protective film having dust removal function, comprising:
a mobile phone film body;
an electrostatic protective film; and
a pulling film;
wherein the electrostatic protective film is disposed on an upper side of the mobile phone film body, the pulling film is disposed on an upper side of the electrostatic protective film; a connecting structure is disposed at a front end of the electrostatic protective film and a front end of the pulling film, and the electrostatic protective film and the pulling film are connected into a whole through the connecting structure.

2. The mobile phone screen protective film having dust removal function according to claim 1, wherein the connecting structure is a connecting film.

3. The mobile phone screen protective film having dust removal function according to claim 1, wherein a pulling portion, distal from the connecting structure, is disposed on the pulling film; and the pulling portion protrudes out of an edge of the electrostatic protective film and an edge of the mobile phone film body.

4. A film pasting auxiliary device for the mobile phone screen protective film having dust removal function according to claim 1, comprising:
a main housing;
a positioning frame;
a film body placing groove;
a positioning avoiding groove;
a pulling opening;
an opening; and
a positioning connecting mechanism;
wherein the opening is defined on the main housing and penetrates through a back surface of the main housing, the positioning frame is distributed in the main housing, the film body placing groove extends out from the positioning frame along a direction of the opening, the positioning avoiding groove is defined on a first side of the positioning frame, the positioning avoiding groove and the film body placing groove are on a same horizontal plane and are formed into a whole, the pulling opening is defined on a second side of the positioning frame, and the positioning connecting mechanism is disposed between the main housing and the mobile phone film body.

5. The film pasting auxiliary device for the mobile phone screen protective film having dust removal function according to claim 4, wherein the positioning connecting mechanism comprises a connecting member, the connecting member is disposed on the back surface of the main housing, the connecting member covers on the opening, and one side, where an adhesive portion is disposed, of the connecting member faces the mobile phone film body.

6. The film pasting auxiliary device for the mobile phone screen protective film having dust removal function according to claim 5, wherein the connecting member is an adhesive sticker.

7. The film pasting auxiliary device for the mobile phone screen protective film having dust removal function according to claim 4, wherein the positioning connecting mechanism comprises a positioning film, positioning sleeve holes, and positioning columns; the positioning film is disposed at a front end of a lower side of the mobile phone film body, the positioning sleeve holes are defined on a front end of the positioning film, the positioning columns are disposed on the positioning avoiding groove on the first side of the positioning frame, and the positioning columns are disposed with respect to the positioning sleeve holes.
